(19) United States
(12) Patent Application Publication
(10) Pub. No.: US 2002/0077943 A1
(43) Pub. Date: Jun. 20, 2002

(54) Determination of margins in a transaction system

(76) Inventors: Brian Bunyan, Kildare Town (IE); Jonathan O'Connor, Leixlip (IE); Stephen Wynne, East Wall (IE)

Correspondence Address: John P. Donohue, Jr., Woodcock Washburn Kurtz, Mackiewicz & Norris LLP, One Liberty Place - 46th Floor, Philadelphia, PA, 19103, US

(21) Appl. No.: 09/808,876

(22) Filed: Mar. 15, 2001

(30) Foreign Application Priority Data
Mar. 15, 2000 (IE) S2000/0206

(51) Int. Cl. G06F 17/60

(52) U.S. Cl. 705/35

(57) ABSTRACT

A transaction system of a supplier includes a margin determination unit comprising margin table memory for storing a plurality of tables (such as financial exchange and money market margin tables), each table having rows for the table name, transaction type, client details or rating, transaction size, transaction currency, instrument type, time period(s), and margin type and amount. A selection module sequentially selects tables from memory and a comparison module compares quantities specified by successive rows of the selected table with corresponding quantities in a transaction request from a client/user. A calculation unit calculates a margin based on information in the table if all comparisons are good; otherwise the next table is selected. A table editor allows easy updating of the tables (adding new tables, and deleting, amending or re-arranging existing tables).

### TECHNICAL FIELD

The present invention relates to automated transaction systems, and more specifically to the determination of operating margins in such systems, particularly financial transaction systems.

### BACKGROUND ART

Financial transaction systems typically provide a variety of financial services, including core services such as FX (foreign exchange, providing a client with money in one currency for payment in another currency) and MM (money market, providing a loan to a client or paying interest on money provided by a client).

An automated financial transaction system generally comprises a user interface where the client makes a request for a particular price. The system includes some kind of processor with which the customer communicates by a digital system rather than voice and which automatically returns a rate or price to the client.

When the client makes a request for a price or a rate, a number of checks are carried out automatically by the system. These may involve credit limit checks as well as validation of the request, e.g. the validation of currencies requested or the validation of a particular product requested.

The system then automatically calculates and returns a price or a rate to the client, using the basic price plus any client-specific margins automatically applied. Upon receipt of the price or rate, the client can then accept or reject the price or the rate.

The system may also provide an operator service for, for example, transactions for sums beyond the customers' normal credit limits, the organization's transaction limits, or for unusual currencies or products requested. For some such requests, e.g. those involving currencies which the organization does not deal with, this may involve the operator in trying to obtain services from some further organization. The system may also be arranged to automatically try to obtain services from other organizations, as described for example in our earlier co-pending U.S. patent application Serial No. 09/434,422.

Most substantial organizations which are in the business of providing financial services have to make profits on the transactions which they carry out for their clients. These profits come out of the service charges made by the organizations.

A wide variety of factors may be taken into account in calculating the appropriate margins to charge for such transactions, such as the type of the transaction (FX or MM), the nature of the particular transaction (e.g. Spot, Forward, or Swap for FX), the client, the client group, the branch, the size of the transaction, and the currencies involved (for FX).

In simple systems, the margin may be calculated manually, possibly involving the discretion of the operator. In automated systems, the margin determination procedure must be defined and programmed into the system. In principle, this is straightforward. But in practice, it rapidly results in considerable complexity, as more and more distinctions and special situations are catered for. Perhaps more seriously, it makes amendment and updating of the system extremely onerous. Adding new distinctions or criteria to an existing program is usually more difficult that writing the program in the first place, and checking that the new distinctions or criteria are consistent with the already existing ones (both as originally programmed and as added by previous amendments) is even worse.

The object of the present invention is to provide a system for calculating margins in financial transactions in which amendment and updating is made easier.

### SUMMARY OF THE INVENTION

According to the invention there is provided a margin determination unit for a transaction system of a supplier, the margin determination unit comprising a margin table memory for storing a plurality of tables, each table having a plurality of rows, a table selector for selecting the tables in sequence, a comparator for comparing quantities specified by successive rows of the selected table with corresponding quantities in a transaction request from a client/user, a calculation unit for calculating a margin under control of information in the table if all comparisons are good, with said table selector selecting the next table if any comparison is bad.

The margin determination means preferably also includes a table editor for adding new tables, deleting tables, amending tables, and re-arranging the sequence of the tables.

Preferably, the tables include rows containing entries selected from the table name, transaction type, client details, transaction size, transaction currency, instrument type, time period(s), and margin type and amount.

The margin determination unit may also include a conflict determination unit for determining whether a table in the table memory is in conflict with an internal rule specified in a rule set.

The tables can be ordered in the table memory and the internal rule may define the ordering of the tables within the memory according to the information contained therein.

The internal rule may define the the internal consistency of information contained within the tables and/or the permitted information which may be contained within the tables based on the capabilities of said transaction system.

The invention further provides a quoting processor comprising a margin determination unit as described above.

In a further aspect the invention provides a financial transaction system (such as a bank transaction system) comprising a margin determination unit or a quoting processor according to the invention.

The invention also provides a method of determining a margin in a transaction comprising the steps of:

receiving a transaction request from a client/user,

selecting a table from a stored set of tables, each table having a plurality of rows,

comparing quantities specified by successive rows of the selected table with corresponding quantities in said transaction request,

calculating a margin under control of information in the table if all comparisons are good, or selecting a further table if any comparison is bad.

### BRIEF DESCRIPTION OF DRAWINGS

An automated financial transaction system embodying the invention will now be described in detail, by way of example, with reference to the drawings, in which:

FIG. 1 is a block diagram of the margin determination means;

FIGS. 2 to 6 are block diagrams of comparison calculation units; and

FIG. 7 is a block diagram of the margin calculation unit.

### DETAILED DESCRIPTION OF PREFERRED EMBODIMENT

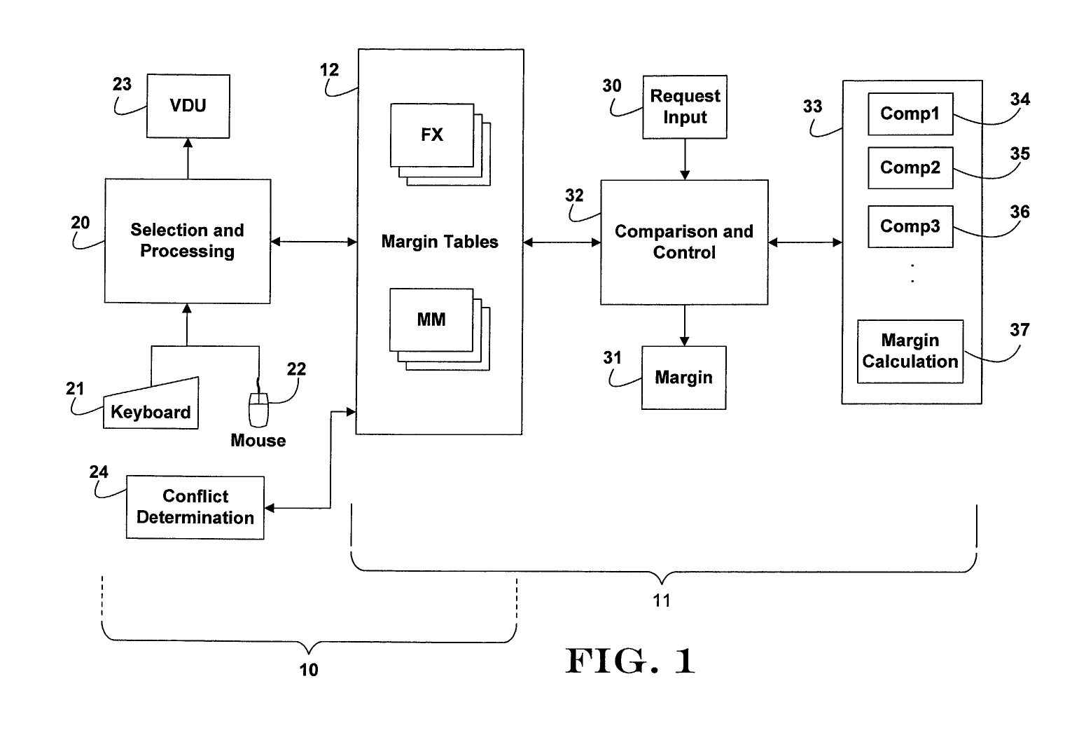

FIG. 1 is a general functional block diagram of the system, which falls generally into two portions, a control portion 10 concerned with generating and updating the margin tables and an operational portion 11 concerned with using the margin tables to determine a margin for a transaction request. These two portions have a margin table memory 12 in common. As shown, the memory 12 contains multiple tables—in this case there are two sets of tables, an FX set of tables 13 and an MM set of tables 14.

It is not strictly necessary for the two sets of tables to be separated. A single set of tables could be used, with each table including a row indicating whether it is an FX or MM table, and each request also containing an indication of whether it is an FX or an MM request. As each table is compared with the request, a comparison of the FX/MM row against the request type would be made, normally as the first comparison. This comparison would fail on a mismatch, so only FX tables would proceed to further analysis for an FX request, and only MM tables for an MM request.

However, it is more convenient to use two separate sets of tables, with only the appropriate set being searched for each request. This simplifies the control procedures for updating the tables; when the FX tables are being updated, only the FX tables are available, with no extraneous intervening MM tables (and vice versa).

As a matter of good operating practice, it is generally desirable to keep tables of similar types together as far as possible, even though, apart from the separation of the FX and MM tables, this is not enforced by the apparatus. The two sets of tables can in fact be regarded as parts of a single sequence or super-set subject to the constraint that all FX tables must necessarily precede the MM tables (or vice versa). More generally, good operating practice also requires related sub-types of table to be kept together in the sequence of tables are far as possible.

The tables are held in sequence. In the simplest form of the table memory, they can be held in that physical sequence in the memory. It may however be convenient to define their sequence by means of a pointer list, chaining them, or some other means for defining the sequence independently of their actual physical locations in the memory.

The control portion 10 of the apparatus comprises a table selection and processing unit 20 which can be used to select a table from the table memory 12, move it to the unit 20, update it, and return the updated table to the memory. The unit 20 can also be used to display the sequence of the tables in the memory 12, generate new tables, delete tables, and re-arrange the sequence of the tables in the memory 12. While a new table can if necessary be generated ab initio, it is often convenient to copy an existing table from the memory, amend it, and move the resulting new table into the memory 12 at a suitable position in the existing sequence of tables.

The unit 20 has the usual peripheral units associated with it for operator interaction, such as a keyboard 21, a mouse 22, and a display unit 23.

The various types of conditions which can be tested by the tables define an abstract space, and each table may be regarded as defining a region of that space—the region in which all the conditions defined by that table are satisfied. It may be that the region defined by one table lies wholly within the region defined by another table. The table with the enclosed (small) region must then precede the table with the enclosing (large) region. For otherwise, any set of conditions lying within the small region will lie within the large region, and if the table with the large region is tested first, it will match and the system will proceed in accordance with that table; the table with the small region will never be reached.

This condition is thus mandatory for good practice. There are two ways of ensuring that it is satisfied. One is for the operator to carry out suitable inspections of the tables (a process which is aided if related tables are kept together). The other is to provide a conflict detector unit 24 for detecting such conflicts between the tables in the table memory. As will be discussed later, this conflict detector can also be used to detect other types of conflict.

The operational portion 11 of the apparatus comprises a request unit 30 which acts as an input unit for receiving a transaction request, a margin storage unit 31 which acts as an output unit in which a resulting margin value is produced, and a comparison and control unit 32 coupled between the input and output units which processes the request in the input unit to generate the margin and store it in the output unit.

The unit 32 is coupled to the table memory 12, and also to a calculation unit 33. Unit 33 contains a plurality of comparison calculation units 34, 35, 36, &c, which are used to carry out a variety of comparison tests, and a margin calculation unit 37 which is used to carry out the calculation of the margin.

When a request is received in unit 30, the comparison unit 32 compares it with each table in turn in the appropriate set of tables in the table memory 12, taking the tables in sequence. Each table comparison involves comparing a plurality of rows of the table, in sequence, against the corresponding elements in the request. There are various different types of tests for the different rows, and there is a separate comparison calculation unit in the calculation unit 33 for each different type of test. If any row comparison fails, then that table does not match the request and the next table is selected.

When a table is reached for which all rows match, the margin section of the table is passed to the margin calculation unit 37. This calculates the amount of the margin for the request, on the basis of the various quantities in the request and the margin rows of the table. The system then (by means not shown) generates a quotation to the customer, including a price which is calculated on the basis of the cost to the organization of performing the transaction plus the margin.

If all tables in the table memory are tested and no match is found, the system may apply a default margin calculation procedure, pass the request to an operator for the operator to deal with, or generate an automatic rejection of the request.

If desired, each list of tables may include a final table with empty test rows and a “default” margin calculation row. This will avoid the possibility of a match not being found.

TABLE 1
FX Table

| Row no | Row description | Row entry |
|---|---|---|
| 1 | Table name | . . . |
| 2 | Transaction type | FX |
| 3.1 | Client name | XYZ Co |
| 3.2 | Client group | XY group |
| 3.3 | Client rating | B |
| 4.1 | Transaction size | 100,000 |
| 4.2 | Size currency | USD |
| 5 | Currency pair | JPY/GBP |
| 6.1 | Instrument | Forward |
| 6.2 | Time | 30 days |
| 7.1 | Margin type | Amount |
| 7.2 | Margin value | 5 |

Table 1 shows an FX table in simplified form. It will be seen that it consists of a number of rows, each identified for convenience by a row number and having a row description and a value entry. The operator can enter and modify the row values by using the control portion 10 of the apparatus, which operates broadly as a type of text editor. Typical entries are shown for most rows.

Row 1 is for operator convenience. The operator can enter a convenient title or identifier in this row. This row is not used by the operational portion 11 of the apparatus for table comparison.

Row 2 defines the transaction type, which is either FX or MM; in this case it is FX.

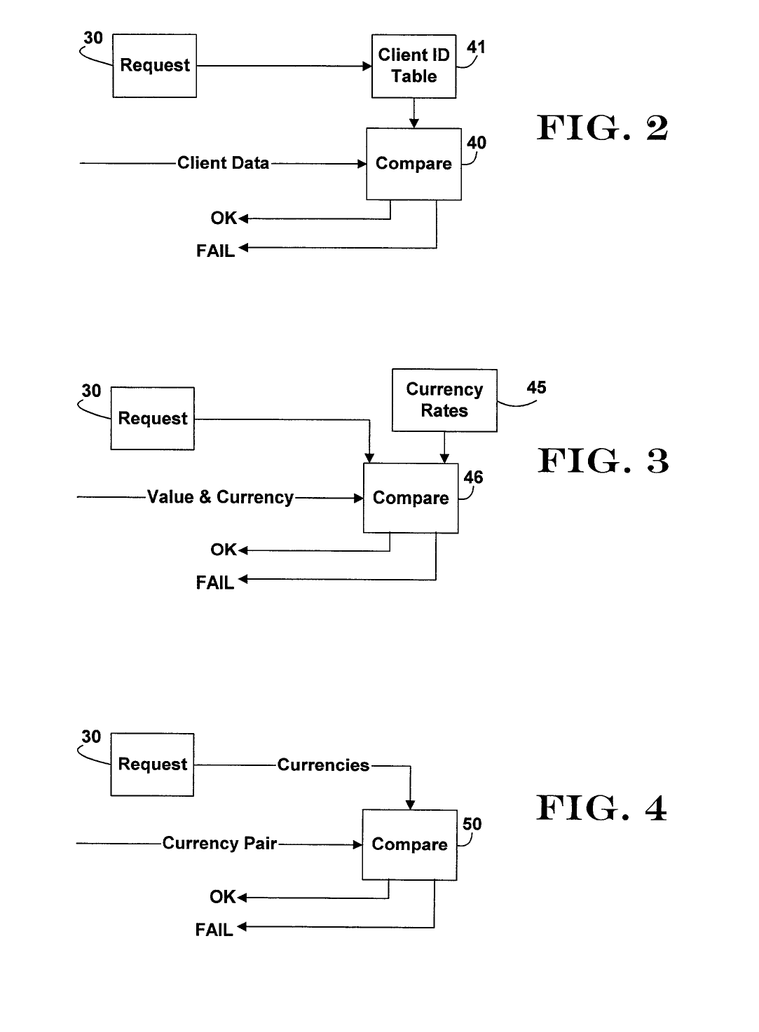

Rows 3.1 to 3.3 define the client. A client can be identified by name, by group, or by rating. These rows are associated with a client test unit forming one of the comparison calculation units 34, 35, 36, etc. of the calculation unit 33. FIG. 2 shows the comparison calculation unit and associated units for these rows.

The system includes a client ID table 41 which lists clients of the system and various information about those clients, including in particular the client name, the client group (if any), and the client credit rating (if any). The client name is included in the request from the client which is stored in the input unit 30. The comparison and control unit 32 causes the client name to be passed to the unit 41, which passes the client name, group (if any), and rating (if any) to a comparison unit 40.

The control unit 32 then inspects rows 3.1 to 3.3 of the table. If row 3.1 contains a client name, that is passed to the comparison unit for comparing with the client name from unit 41. If there is a match, the system skips to row 4. If there is no match, or row 3.1 does not contain a client name, unit 32 moves to row 3.2. If row 3.2 contains a client group, that is passed to the comparison unit for comparing against the client group from unit 41. If there is a match, the system skips to row 4. If there is no match, row 3.2 does not contain a client group, or the client ID table 41 does not contain a client group for that client, unit 32 moves to row 3.3. If row 3.3 contains a client rating, that is passed to the comparison unit for comparing against the client rating from unit 41. If there is a match, the system skips to row 4. If there is no match, row 3.3 does not contain a client rating, or the client ID table 41 does not contain a client rating for that client, the match of the table fails and unit 32 selects the next table.

The system may be constrained in various ways. For example, if there is a client name in row 3.1, the system may require the client name to match a client name in the client ID table 41. This constraint may be implemented by the conflict detector 24, which will compare a client name entered in row 3.1 with the client ID table 41 when the table is being generated or edited and refuse to accept a name which is not in that table. Similarly, if there is a client name, the conflict detector 24 may prevent a client group or rating being entered in rows 3.2 and 3.3.

Rows 4.1 and 4.2 specify a transaction size. Since the transaction is an FX transaction, a currency must be entered in row 4.2 as well as a value in row 4.1. FIG. 3 shows the comparison calculation unit and associated units.

The system includes an exchange rate unit 45 for defining and maintaining a variety of exchange rates. The transaction request unit 32 feeds the currency and size of the request to the comparison calculation unit 46, which also receives the transaction size limit and size currency from the current FX table as selected by the control unit 32. The unit 46 calculates the size of the transaction, by multiplying the size from the transaction unit 30 by the conversion factor (obtained from unit 45) between the currency of that request and the currency of line 4.2, and compares the result with the size value in line 4.1. If the size of the request is less than or equal to the size defined in the FX table, there is a good match; if not, there is no match and the unit 32 proceeds to the next table.

Again, the system may be constrained in various ways. In particular, the system may require that FX tables which differ only in the transaction size in row 4.1 must be arranged in sequence order of ascending transaction size, so that the first match which is achieved for rows 4.1 and 4.2 is for the table with the smallest transaction size which matches (equals or exceeds) the actual requested transaction size.

Row 5 contains the two currencies of the request, i.e. the currencies which the client wants to convert from and to. FIG. 4 shows the comparison calculation unit 50 and associated units for this row. The comparator 50 is fed with the two currencies of the request (from unit 30) and the two currencies of row 5. If there is a match, the system proceeds to the next row of the table. If there is a mismatch, i.e. if either currency of the pair in the row is not the same as one of the currencies of the request, there is a mismatch, and the system proceeds to the next table. The comparison may be required to match the first currencies of the two pairs and the second currencies of the pairs, or may permit cross-matching between first and second currencies.

This row is subject to a system constraint, that the currency pair must be supported by the system. This constraint is implemented by the conflict detector 24, which checks the currency pair with the currency pairs listed in unit 45 (FIG. 3).

Row 6.1 contains the instrument type. The system supports all types of FX and MM instruments, but in the present embodiment, three instrument types are dealt with: Spot, Forward, and Swap. FIG. 5 shows the comparison calculation unit 55 and associated units for this row. The comparator 55 is fed with the two instrument types, from the request unit 30 and row 6. If the two types are identical, or if no instrument type is specified in row 6, there is a match; otherwise there is a mismatch.

Row 6.2 specifies a time period. This row is disregarded for Spot transactions or if no transaction type is specified in row 6.1. FIG. 6 shows the comparison calculation unit 60 and associated units for this row. A test is performed for this row if a time period is necessary for the transaction, as in the case where a Forward or Swap transaction is specified in row 6.1. The system contains a date unit 61 which specifies the current date, and unit 60 adds the period to this current date to determine a limit date.

For a Swap transaction, the unit 60 then compares that limit date with the date specified in the request unit 30; if the date from unit 30 is later than the limit date there is no match. For a Forward transaction, the system contains a configuration flag 62 which is set to indicate the near date, the far date, or the difference between the near and far dates. If the flag is set to the far date, the comparison calculation unit 60 operates as for a Swap transaction, using the far date from the request. If the flag is set to the near date, the unit 60 compares the limit and the near date—if the limit is later than the near date, there is a match. If the flag is set to the difference, the unit 60 compares the limit with the near and far dates from the request unit—there is a match only if the limit is within the range from the near date to the far date.

Obviously, a row can be added to the tables to specify the nature of the comparison in the case of Forward transactions; in effect this will allow different flag settings for different tables.

If all tests are successful, i.e. all comparisons result in good matches, the table is operative for the transaction requested. The control unit 32 then selects the margin calculation unit 37 to calculate the margin. For this, rows 7.1 and 7.2 of the table are used.

Row 7.1 specifies the margin type, which can be Pips, Percentage, or Amount. The Pips type specifies a number of units of the relevant currency; the Percentage type specifies a percentage of the transaction value; and the Amount type specifies an absolute amount. The Pips type may specify which of the two currencies is to be used.

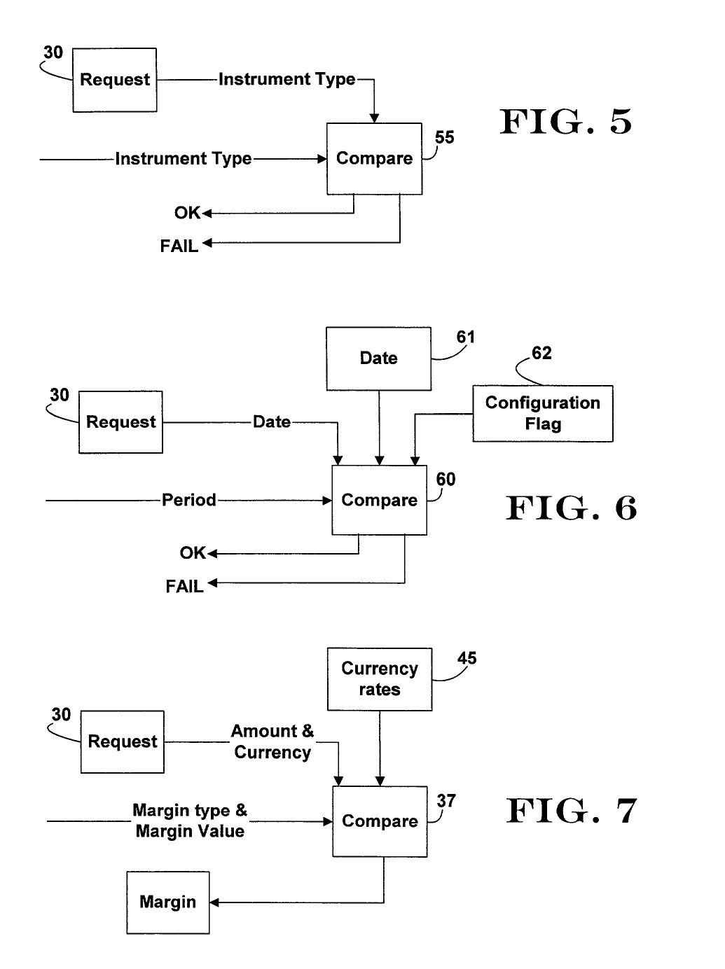

FIG. 7 shows the margin calculation unit 37 and associated units. This is fed with the margin type and value from the table in unit 32, the value and currencies from the request unit 30, and the currency exchange rates from unit 45. It calculates the appropriate margin, as defined by rows 7.1 and 7.2 of the table, and (if appropriate) the currencies and value from the input unit 30. It will normally also convert the result into the local currency used by the organization. The result is passed to the margin unit 31.

When the margin has been calculated, the request processing system containing the margin determination unit will add that value to the other costs of the requested transaction to produce a quotation or bill to the client.

MM tables are generally similar, but differ in detail. Rows 1 to 4.1 are the same (apart from the type MM in row 2). Row 4.2 may be omitted, or may be used but specifying only a single currency. Row 6.1 can specify any MM instrument, such as Loan or Deposit. Row 6.2 is used in much the same way as in FX tables. Row 7.1 can be used to specify margin types Fraction/decimal, Rate percent, and Amount.

Obviously some of the comparison calculation units described above for FX tables will also be used for MM tables, but for those rows where FX and MM tables differ, the comparison calculation units will need to be modified to perform the MM calculations as well, or additional comparison calculation units for the MM calculations will be required.

The tables have been described as having a fixed number of rows (albeit that some rows may be disregarded). The system can however be extended to permit some rows to be repeated to form a group of rows. For example, row 5 may be repeated, to allow a single table to specify several different currency pairs. If rows are allowed to be repeated in this way, the comparison and control unit 32 will treat a match of any row of the group as a valid match for the group.

The margin calculation may of course be elaborated, e.g. to allow a margin to be calculated as a fixed quantity plus a percentage of the amount of the transaction, by suitable design of the margin calculation unit and the provision of suitable information or parameters in the table.

It will be understood that the margin determination apparatus is shown in a highly diagrammatic and simplified form. Additional lines could be included in the tables for additional tests, with the appropriate additional comparison calculation units being provided in the calculation unit 33. Also, other details could or would need to be stored in the tables for different types of trade.

We claim:

1. A margin determination unit for a transaction system of a supplier, the margin determination unit comprising a margin table memory for storing a plurality of tables, each table having a plurality of rows, a table selector for selecting the tables in sequence, a comparator for comparing quantities specified by successive rows of the selected table with corresponding quantities in a transaction request from a client/user, a calculation unit for calculating a margin under control of information in the table if all comparisons are good, with said table selector selecting the next table if any comparison is bad.

2. A margin determination unit as claimed in claim 1, further comprising a table editor for adding new tables, deleting tables, amending tables, and re-arranging the sequence of the tables.

3. A margin determination unit as claimed in claim 1, wherein the tables include rows containing entries selected from the table name, transaction type, client details, transaction size, transaction currency, instrument type, time period(s), and margin type and amount.

4. A margin determination unit as claimed in claim 1, further comprising a conflict determination unit for determining whether a table in the table memory is in conflict with an internal rule specified in a rule set.

5. A margin determination unit as claimed in claim 4, wherein said tables are ordered in the table memory and wherein said internal rule is a rule defining the ordering of the tables within the memory according to the information contained therein.

6. A margin determination unit as claimed in claim 4, wherein said internal rule is a rule defining the internal consistency of information contained within said tables.

7. A margin determination unit as claimed in claim 4, wherein said internal rule is a rule defining the permitted information which may be contained within said tables based on the capabilities of said transaction system.

8. A quoting processor comprising a margin determination unit, the margin determination unit comprising a margin table memory for storing a plurality of tables, each table having a plurality of rows, a table selector for selecting the tables in sequence, a comparator for comparing quantities specified by successive rows of the selected table with corresponding quantities in a transaction request from a client/user, a calculation unit for calculating a margin under control of information in the table if all comparisons are good, with said table selector selecting the next table if any comparison is bad.

9. A financial transaction system comprising a margin determination unit, the margin determination unit comprising a margin table memory for storing a plurality of tables, each table having a plurality of rows, a table selector for selecting the tables in sequence, a comparator for comparing quantities specified by successive rows of the selected table with corresponding quantities in a transaction request from a client/user, a calculation unit for calculating a margin under control of information in the table if all comparisons are good, with said table selector selecting the next table if any comparison is bad.

10. A method of determining a margin in a transaction comprising the steps of:
receiving a transaction request from a client/user,
selecting a table from a stored set of tables, each table having a plurality of rows,
comparing quantities specified by successive rows of the selected table with corresponding quantities in said transaction request,
calculating a margin under control of information in the table if all comparisons are good, or selecting a further table if any comparison is bad.

11. A method as claimed in claim 10, wherein the tables include rows containing entries selected from the table name, transaction type, client details, transaction size, transaction currency, instrument type, time period(s), and margin type and amount.
